(19) United States
(12) Patent Application Publication
(10) Pub. No.: US 2011/0210633 A1
(43) Pub. Date: Sep. 1, 2011

(54) Multi-Phase Rotating Motor

(75) Inventor: Wei-Ting Lu, Taiwan (TW)

(73) Assignee: UNION PLASTIC (HANGZHOU) MACHINERY CO., LTD., Linan, Zhejiang (CN)

(21) Appl. No.: 12/672,595

(22) PCT Filed: Aug. 19, 2008
(86) PCT No.: PCT/CN2008/072040

§ 371 Date: Feb. 8, 2010

(30) Foreign Application Priority Data
Aug. 21, 2007 (CN) 200710009401.3

(51) Int. Cl. H02K 16/00

(52) U.S. Cl. 310/114

(57) ABSTRACT

A multi-phase rotating motor causes interpolar mutually-coupled magnetic potential gradient of a field magnet member and an armature member to be prearranged by providing desired shape of pole face for two magnetic pole faces of magnetic assemblies of the field magnet member and the pole faces of the paired poles of electromagnetic assemblies of the armature member, thus controlling detent torque to be varied as desired; and multi-phase arrangement is utilized to further balance the unwanted detent torque in order to guarantee that magnetic flux centralization as well as minimization for magnetic flux loss and of interference effect in motor characteristics are hardly influenced. In addition, with the help of two or more than two magnetic tracks, more parallel air gaps are added in three-dimensional space of the motor to cause the motor, by means of the difference between the magnetic track to which the electromagnetic assemblies of the each-phase unit are corresponding and the magnetic track to which the electromagnetic assemblies of other phase units, to obtain the benefit that higher torque output is provided or more serially-connected and independently-moving individuals are simultaneously arranged, on condition of limited movement direction space.

### FIELD OF THE INVENTION

The present invention relates to a multi-phase rotating motor structure, more particularly, the present invention indicates that each-phase unit of armature members of the multi-phase rotating motor is mutually magnetically isolated from other each-phase units, and pole faces of two magnetic poles of two-magnetic-pole-containing magnetic assemblies of field magnet members are configured to be opposite to each other in a first direction which is vertical to a circumferential direction in which a rotating shaft surrounds, two pole faces of paired-pole-containing electromagnet assemblies of the armature members are configured to be opposite to each other in the first direction which is vertical to the circumferential direction in which the rotating shaft surrounds.

### BACKGROUND OF THE INVENTION

To a general rotating motor, magnetic principle of repulsive like and attractive unlike is used between rotors and stators of a DC motor or an AC motor regardless of operation thereof.

Kawai and others proposes a power generation device in U.S. Pat. No. 5,436,518, magnetic paths of a plurality of electromagnets of stators thereof are arranged independent of each other. As the magnetic paths of the electromagnets are arranged independent of each other, the electromagnets are individually magnetized respectively in order to be irrelevant to other electromagnets, and sequential excitation is implemented on the electromagnets to control the motion of rotors in a predetermined direction. Conversion interference effect of magnetic flux between adjacent coils are processed by means of arranging the electromagnets independent of each other in order that power used for the electromagnets can be effectively utilized to a maximum extent to thereby reduce the interference impeding the motion of the rotors as far as possible.

Maslov and others proposes a brushless rotating motor in China patent application publication No. CN1650501 and also in China patent application publication No. CN2812392 with LU Weiting and others. Conversion interference effect of magnetic flux between adjacent coils are processed by means of the arrangement of electromagnet pole pairs independent of each other on the armature, and extremely-centralized magnetic flux distribution is provided by magnets of field magnetic pole and electromagnetic pole pair of armature which are arrayed in a movement direction, so as to enable magnetic flux to be centralized on relatively large surfaces to form high torque, and meanwhile, disadvantageous influence caused by geometric imbalance when a single coil operates can be reduced. And a sensor is used for sensing relative position of the field magnetic pole and the armature, and smooth operation of the motor is resulted from the appropriate control of coil currents on the electromagnetic pole pair of the armature at different time respectively.

In order to obtain larger total effective gap surface area, in China patent application publication No. CN101005229 and CN1897424, LU Weiting and others realizes the providence of larger magnetic flux distribution by increasing the surface of the electromagnetic pole pair of the armature of the motor and corresponding surface of the magnet of the field magnetic pole, and also realizes improved magnetic flux distribution by the centralization of magnetic flux. The structure of motor framework provides larger continuous magnetic flux generation path between the magnet of the field magnetic pole and the electromagnet of the armature by increasing surface area of the magnet of the field magnetic pole passing through a plurality of air gaps and of the corresponding electromagnetic pole pair of the armature, in order to enable the magnetic flux to be centralized in a relatively large surface to further increase high torque ability of the motor and to take spatially geometric balance of the single coil of the motor into consideration.

Kawai, Maslov, LU Weiting and others confirm, in the patents, the centralization and the utmost utilization of the magnetic flux, minimization for magnetic flux loss and interference effect, larger total effective gap surface area and obtained better spatially geometric balance of the motor, so as to obtain characteristics of the motor including high efficiency, high torque and safe and flexible operation, which have been described in the above patent application. Although the electromagnet formed by the connection of core part of magnetic conductivity and the paired poles can provide larger torque when the coils of the electromagnetic assemblies in the motor are excited by current, a plurality of magnetically-isolated coil-containing electromagnetic assemblies form additional detent torque when permanent magnets pass by the electromagnets to cause pulsation of output torque, which disadvantageously impacts on the operation of the motor.

In the brushless motor, the detent torque is one of the principal factors which reduces control performance of the motor, so in order to reduce the disadvantageous impact from the detent torque, more phase clusters can be utilized to control reluctance change rate between rotors and stators.

However, in the motor proposed in the above patents by Maslov, LU Weiting and others, when the number of the electromagnetic pole pairs on the armature is equal to the number of the magnet pairs of the magnetic assemblies of the field magnetic pole, each of the gaps of the armature magnetically isolating between the adjacent electromagnetic pole pairs in the circumferential direction of the rotating shaft is equal to each other in size and each of the adjacent gaps of the magnetic assemblies of the field magnetic pole isolated from each other in the circumferential direction of the rotating shaft is equal to each other in size, a single-phase structure is formed in the motor. But the single-phase structure of the motor causes, when the pole face of certain electromagnet and the magnetic pole face of the corresponding magnetic assemblies face each other, the pole face of each of other electromagnets and the magnetic pole face of one of the corresponding magnetic assemblies face each other for sure. In this case, although movement direction space can be utilized effectively to obtain larger total effective gap surface area, the direction of acting force between the electromagnetic assemblies and the magnetic assemblies is vertical to the movement direction for sure regardless of the existence of excitation currents in the coils of the electromagnetic assemblies of the motor, without generating action force applied to the movement direction, which is accordingly disadvantageous for the operation of the motor.

Although a great many of technologies, such as reducing the magnetic flux of the motor or arranging interpolar spaces to generate effect similar to multi-phase with different spacing in a movement direction, are used for reducing disadvantageous impact from the detent torque generated due to the existence of the electromagnets, reducing the magnetic flux of the motor causes decreased output, or varies single-phase structure of the motor, according to requirement, different spacing is arranged for the interpolar spaces of the adjacent electromagnetic assemblies in the circumferential direction in which the rotating shaft surrounds and for the interpolar spaces of the adjacent magnetic assemblies, and each electromagnetic assembly is excited at proper time to obtain the acting force applied to the movement direction; however, the arrangement of the interpolar spaces with different spacing utilizes benefits of movement directions space as far as possible and obtains available motor operation, but complexity and difficulty are added to control and design, and it is liable to generate disadvantageous impact of spatially geometric imbalance of the motor.

Accordingly, in order to lead the motor to obtain electromagnetic force applied to the movement direction and improve geometric balance, Maslov, LU Weiting and others, in the above patents, gives the motor structure easiness for forming a multi-phase structure to thereby result in available operational characteristics by appropriately arranging the number of the electromagnetic pole pairs on the armature to be different from the number of the magnet pairs of the magnetic assemblies of the field magnetic pole. In addition, the multi-phase arrangement of the motor structure can release disadvantageous impact from the detent torque thereof and reduce disturbance of controlling the motor in order to easily achieve smooth operation of the motor and improve geometric balance.

In order to further obtain larger total effective gap surface area, in China patent application publication No. CN2812392, LU Weiting and others refers to combining two motors in CN2812392 in a manner of radially serial connection into a brushless rotating motor without additional position sensor, so that required smooth operation can be achieved by respectively implementing appropriate excitation on all the coils at appropriate time. Furthermore, LU Weiting and others proposes a framework on a radialy serial connection structure in China patent application publication No. CN1949639 and Maslov and others proposes a framework on a axially serial connection structure in U.S. Pat. No. 6,762,525, for the purpose of providing highly-centralized magnetic flux distribution. In order to obtain highly-centralized magnetic flux distribution thereby causing high torque ability of the motor, the adjacent rotors on the serial connection structure share a shared side wall. In these structures, however, in order to result in smooth operation of the motor, the construction of each motor in the serial connection structure in which a plurality of motors are serially connected still remains originally arrangement when actual usage is discussed, as a result, characteristics of the motor of these structures should be almost completely similar to original characteristics of the motor, so similar advantages and limitations are included.

To any motor structure with the multi-phase arrangement, in a two-phase motor with two groups of phase coils, two phase currents are an alternating current sine wave and are mutually offset at a 90-degree phase.

In a three-phase motor with three groups of phase coils, three phase currents are all an alternating current sine wave and are mutually offset at a 120-degree phase.

For the simplification, the present invention makes a reference to three-phase operation of the commonest three-phase motor, and all the descriptions of the present invention are also effective to the motor having phases more than or less than three.

FIG. 1A is a recognized plan view for electromagnetic force in traditional three-phase linear motor. The FIG shows plan expanded views of each-phase electromagnetic force Fa, Fb and Fc applied in the movement direction and prearranged by the traditional three-phase linear motor in each position of the movement direction, therefore, three-phase alternating current in three-phase coils of the armature leads combined force F of the each-phase electromagnetic force Fa, Fb and Fc to a fixed value and displays the value in the FIG.

Corrective operation of the three-phase motor is appropriate as described hereinabove; to three phases, each is composed of at least one induction coil and must be composed in a motion direction until a column of coils is formed; when all the phases are allocated in such a manner, a considerably large amount of spaces are occupied in the motion direction of the motor itself.

The traditional three-phase linear motor has taken balances into consideration, but the application with limited movement direction space but requiring high torque can be conquered by increasing more parallel air gaps to further increase effective air gap surface area, so that the motor can provide higher torque in case of limited increase of the movement space.

FIG. 1B shows the arrangement of fundamental components of three-phase linear motor in accordance with recognized processes. The FIG. 1B shows how to arrange a magnet 6 and phase coil 5a, 5b and 5c in the three-phase linear motor, and, in each phase coil, circulation of an alternating sine wave with 120-degree phase offset with respect to adjacent coils, thus achieving the effect shown as the FIG. 1A; such an arrangement can provide higher torque output by increasing more parallel air gaps, or simultaneously arrange more serially-connected and independently-moving individuals, under the limited length of the movement direction, wherein, a strip object 8 of the ferromagnetic material can server as a magnetic flux return path for adjacent magnets arrayed in the movement direction, however, such a structure leads the centralization of the magnetic flux to be impacted due to adjacent magnetic poles.

In addition, various technologies can be used for controlling reluctance change rate between rotors and stators, wherein, unwanted detent torque is balanced by varying polar surface shape of stator poles or rotor poles and by obliquely relating the geometric shape of the stator polar surface to the geometric shape of the rotor magnet surface; such an oblique arrangement can inhibit change rate of the amplitude of the detent torque so that the motor can reduce disadvantageous impact from the detent torque as far as possible without being adverse to original magnetic flux centralization performance of brushless motor.

In consideration of the above problems, the present invention increases and improves these operational principals and applies the operational principals to the motor of the present invention.

Accordingly, a requirement is present in multi-phase rotating motor, which is to reduce pulsation of output torque caused by detent torque and more effectively utilize the movement space of the motor in the circumferential direction in which the rotating shaft surrounds.

### SUMMARY OF THE INVENTION

The present invention solves the defects that detent torque of the existing multi-phase rotating motor causes pulsation to output torque and that control manner of multi-phase structure is much too complex, and provides a multi-phase rotating motor to reduce the pulsation caused by the detent torque to the output torque; and while disadvantageous impact of the detent torque to the output torque is reduced, the motor can additionally provide higher torque output on condition of limited movement direction space with the help of a field magnet member including two or more than two magnetic tracks by means of multi-phase arrangement of armature members, or in the meantime, much more serially-connected and independently-moving individuals are arranged to more effectively utilize the movement space of the motor in the movement direction and simultaneously simplify the control manner of the multi-phase structure, facilitating actual usage.

In order to realize the above requirements, a multi-phase rotating motor of the present invention comprises:

a field magnet member, including two or more than two magnetic tracks, wherein, each of the said magnetic tracks is configured in a circumferential direction of magnetic assemblies comprising two magnetic poles in which a rotating shaft surrounds, to form an annular ring, and each magnetic pole face of the said two magnetic poles of each magnetic assembly only shows a single magnetic field polarity and the magnetic field polarity is opposite to the magnetic field polarity of the other magnetic pole face;

An armature member, which includes a multi-phase unit, wherein, each-phase unit comprises at least one electromagnetic assembly including paired poles, the said each-phase unit is magnetically isolated from other phase units, and each pole of each electromagnetic assembly comprises respective pole face;

wherein, the said electromagnetic assembly of the said each-phase unit of the said armature member is coaxially configured with one of the said magnetic tracks of the said field magnet member in the circumferential direction in which the rotating shaft surrounds, and two magnetic pole faces of each magnetic assembly are configured to be opposite to each other in the first direction vertical to the circumferential direction in which the rotating shaft surrounds, and each pole face of the said electromagnetic assembly of the said each-phase unit is separated by air gap from one of magnetic pole faces of the magnetic assembly of the coaxially configured magnetic track;

the multi-phase rotating motor is characterized in that: the said magnetic track to which the said electromagnetic assembly of the said each-phase unit is corresponding, is different from the said magnetic track to which the said electromagnetic assembly of other phase unit is corresponding; the magnetic assemblies with different magnetic tracks are mutually dislocated; adjacent magnetic assemblies inside the said magnetic track have equal interpolar space in the circumferential direction in which the rotating shaft surrounds; in addition, a relative movement between the said armature member and the said field magnet member is caused by flowing an alternating current with preset offset on the said electromagnetic assembly of the said each-phase unit which is coaxially configured with one of the said magnetic tracks of the said field magnet member.

Further, each pole face of the said electromagnetic assembly is geometrically different from the surface of the corresponding magnetic pole face of the corresponding magnetic assembly with an air gap separated.

Further, the said electromagnetic assembly has coils and a magnetic-permeable connection part, when the coils of the said electromagnetic assembly are subjected to current excitation, a single magnetic field polarity is generated on each pole face of the said electromagnetic assembly and opposite magnetic field polarities are generated on the adjacent pole faces of the said electromagnetic assembly, and when the currents passing through the coils reverse, the said magnetic field polarity of each pole face of the said electromagnetic assembly reverses therewith.

Further, each magnetic pole of the magnetic assembly of each said magnetic track of the said field magnet member and adjacent magnetic poles of the adjacent magnetic assemblies arrayed in the circumferential direction in which the rotating shaft surrounds, are continuously and alternatively configured in magnetic pole polarity in the circumferential direction in which the rotating shaft surrounds.

The multi-phase rotating motor of the invention can cause magnetic potential gradient of mutual coupling between the magnet member and the armature member to be arranged in advance by providing desired shape of pole face for two magnetic pole faces of the magnetic assembly of the field magnet member and for paired pole face of the electromagnetic assembly of the armature member, in order to control detent torque to vary as desired, and utilizes multi-phase arrangement to further balance unwanted detent torque in order to guarantee that magnetic flux centralization of motor characteristics as well as minimization for magnetic flux loss and interference effect. In addition, with the help of the field magnet member including two or more than two magnetic tracks, more parallel air gaps are added in three-dimensional space of the motor to cause the motor to obtain benefits of providing higher torque output or simultaneously arranging more serially-connected and independently-moving individuals on condition of limited movement direction space, by means of the difference between the magnetic track to which the electromagnetic assembly of the each-phase unit is corresponding and the magnetic track to which the electromagnetic assembly of other phase unit.

The armature member included in the rotating motor of the invention is provided with the magnetically-isolated electromagnetic assembly for interacting with the field magnet member of permanent magnet, thus resulting in magnetic flux centralization and even utilization of power and further achieving more even utilization of power by means of increasing the pole face area of the field magnet member passing through the air gap, and the corresponding armature member.

An objective of the invention is to provide a multi-phase rotating motor, which can, with the help of the field magnet member including two or more than two magnetic tracks, retain considerable space in the movement direction when aiming at individuals requiring smaller output torque by means of multi-phase arrangement of the armature member of the motor, in order to arrange more independently-moving individuals according to the requirement.

Another objective of the invention is to provide a multi-phase rotating motor, which increases more parallel air gaps to cause the motor to provide higher torque on condition of limited increase of space with the help of the field magnet member including two or more than two magnetic tracks by means of multi-phase arrangement of the armature member of the motor.

The principal objective of the invention is to provide a multi-phase rotating motor, which has, aiming at characteristics of rotating motor, evener utilization of power, magnetic flux centralization, and removal of interference effect caused by magnetic flux conversion between adjacent coils, and which causes the rotating motor to be related to the magnetic pole face of the field magnet member and to the pole face of the corresponding armature member so as to be mutually oblique be means of multi-phase arrangement of the armature member, so that the motor can considerably reduce and balance pulsation caused by the detent torque to the output torque.

In accordance with the principal objective, by means of a geometric configuration mode of properly arranging the relation between the magnetic pole face of the field magnet member and the pole face of the corresponding armature member, change rate of the detent torque between the permanent magnet and the electromagnet in the multi-phase rotating motor is controlled, advantages of magnetic flux centralization is maintained, and balancing disadvantageous impact caused by the detent torque to the output torque is further realized.

Another principal objective of the invention is to provide a multi-phase rotating motor, in order to overcome the fact that a sequential multi-phase electromagnet is arranged in the movement direction so that many of the spaces of the motor in the movement direction are occupied, a plurality of serially-connected and independently-moving individuals are arranged simultaneously in the spaces of the motor in the movement direction; the magnetic pole face of the field magnet member and is related to the pole face of the corresponding armature member to be mutually oblique with the help of the field magnet member including two or more than two magnetic tracks by means of multi-phase arrangement of the armature member, so that the multi-phase rotating motor can considerably reduce and balance pulsation caused by the detent torque to the output torque and the motor can simultaneously arrange more serially-connected and independently-moving individuals on condition of limited movement direction space.

Another principal objective of the invention is to provide a multi-phase rotating motor, the magnetic pole face of the field magnet member and is related to the pole face of the corresponding armature member to be mutually oblique with the help of the field magnet member including two or more than two magnetic tracks by means of multi-phase arrangement of the armature member of the motor, so that the multi-phase rotating motor can considerably reduce and balance pulsation caused by the detent torque to the output torque and the motor can further increase effective air gap surface area so as to provide higher torque on condition of limited increase of space.

Another principal objective of the invention is to provide a multi-phase rotating motor, larger magnetic flux distribution is provided and the magnetic pole face of the field magnet member and is related to the pole face of the corresponding armature member to be mutually oblique with the help of the field magnet member including two or more than two magnetic tracks by means of multi-phase arrangement of the armature member of the motor and increasing surface of the electromagnetic pole pair of the armature of the motor and the corresponding surface of the magnet of the field magnetic pole, so that the motor can further increase effective air gap surface area so as to provide further high torque on condition that the space is hardly increased.

In case that the description of the invention is carefully considered, the additional advantages of the invention are changed into easily-implemented processes obviously soon. When the invention is actually implemented, the invention may include other various, incompletely-identical substantiation measures; the invention can be implemented only by modifying several details of the invention instead of deviating from viewpoints and specifications of various technical matters recorded on application patent scope described in the invention. Accordingly, description and drawing made by the present invention herein are only substantial specification, not limitation to actual implementation.

The invention has the advantages that: multi-phase structure is realized in case of equal interpolar space between the adjacent magnetic assemblies inside the magnetic track, thus simplifying control manner of the motor and facilitating actual application; the pole face of the electromagnetic assembly is geometrically different from the pole face of the corresponding magnetic assembly, which can release pulsation caused by the detent torque to the output torque and increase effective air gap surface area to thereby enhance torque output on condition that the space is hardly increased.

### BRIEF DESCRIPTION OF THE DRAWINGS

FIG. 1A is a recognized plan view for electromagnetic force in traditional three-phase linear motor.

FIG. 1B is an arrangement for fundamental components of three-phase linear motor in accordance with recognized processes.

FIG. 2 is an exemplary cutaway view for field magnet member as rotor and armature member as stator in rotating motor in China Patent Publication No. CN1897424.

FIG. 3 is a three-dimensional exploded view resulted from axial arrangement of the combination of three motors in FIG. 2.

FIG. 4A is a partially detailed sectional view for motors in FIG. 3.

FIG. 4B is a partially detailed sectional view for a varied structure similar to FIG. 4A, which is the partially detailed sectional view resulted from radial arrangement of preferable embodiments of three rotating motors in China Patent Publication No. CN1897424.

FIG. 4C is a partially detailed sectional view for the other varied structure similar to FIG. 4A, which is the partially detailed sectional view resulted from axial arrangement of preferable embodiments of three rotating motors in China Patent Publication No. CN101005229.

FIG. 5 is a schematic diagram for the partial planar layout of magnetic pole face of one of two magnetic poles of the magnetic assembly of the field magnet member of the motor and corresponding pole face of the paired poles of the electromagnetic assembly of the corresponding armature member, in accordance with FIG. 4A.

FIG. 6 is a schematic diagram for the partial planar layout of the surface of the magnetic pole face of one of two magnetic poles of the magnetic assembly of the field magnet member of the multi-phase rotating motor and corresponding pole face of the paired poles of the electromagnetic assembly of the corresponding armature member, in accordance with the first embodiment of the present invention.

FIG. 7 is a schematic diagram for the partial planar layout of the surface of the magnetic pole face of one of two magnetic poles of the magnetic assembly of the field magnet member of the multi-phase rotating motor and corresponding pole face of the paired poles of the electromagnetic assembly of the corresponding armature member, in accordance with the second embodiment of the present invention.

FIG. 8 is a schematic diagram for the partial planar layout of one varied structure, which is similar to the schematic diagram for the planar layout in FIG. 7, in accordance with the third embodiment of the present invention.

FIG. 9 is a schematic diagram for the partial planar layout of the other varied structure, which is similar to the schematic diagram for the planar layout in FIG. 8, in accordance with the fourth embodiment of the present invention.

FIG. 10 is a schematic diagram for the partial planar layout of one varied structure, which is similar to the schematic diagram for the planar layout in FIG. 7, in accordance with the fifth embodiment of the present invention.

FIG. 11 is a partial three-dimensional exploded view for an each-phase unit of one of the phases in the armature member of the three-phase rotating motor, in accordance with the sixth embodiment of the present invention.

FIG. 12 is a constitutional diagram of partial three-dimensional exploded view for an each-phase unit of one of the phases in the armature member with structure in FIG. 11.

FIG. 13A to FIG. 13L are embodiments of planar layout of various configuration of paired poles of the electromagnetic assembly and pole face parts of two magnetic poles of the magnetic assembly in the multi-phase rotating motor, in accordance with the present invention.

### SPECIFICATION FOR SYMBOLS OF MAIN COMPONENTS

Magnet 6 Strip object 8 Phase coils 5a, 5b, 5c
Combine force F Each-phase electromagnetic force Fa, Fb, Fc
Outer ring of rotor 83 Rotating shaft 74
Permanent magnets 51, 52, 51c1, 52c1, 51c2, 52c2, 51c3, 52c3, 51d, 52d, 51a1
joint holder 55 of the magnetic assembly
core part 63 of the electromagnetic component
paired poles of the electromagnetic component 61, 62, 61c1, 62c1, 61c2, 62c2, 61c3, 62c3, 61d, 62d, 61a1, 61a2, 62a2 coils 65, 65c1, 65c2, 65c3 of the electromagnetic component air gaps 21, 22 separating stator from rotor
interpolar spaces 32, 32a adjacent to the magnetic assembly in the movement direction
interpolar spaces 33 adjacent to the electromagnetic component in the movement direction
field magnet members C1, C2, C3
armature D1, D2, D3
rotor disk 80
joint holder 69 of the electromagnetic component
stator fixing posts 601c1, 601c2, 601c3
fixed plate 611a1
hole 611aa of the fixed plate at a joint of elongated sheets
fixed assembly 611ab

### DETAIL DESCRIPTION OF THE INVENTION

The brushless rotating motor of the present invention is suitable for high-efficiency generator and electric motor, and can be used for driving engine of special devices such as electric wheel, electric bicycle, electric car and the like.

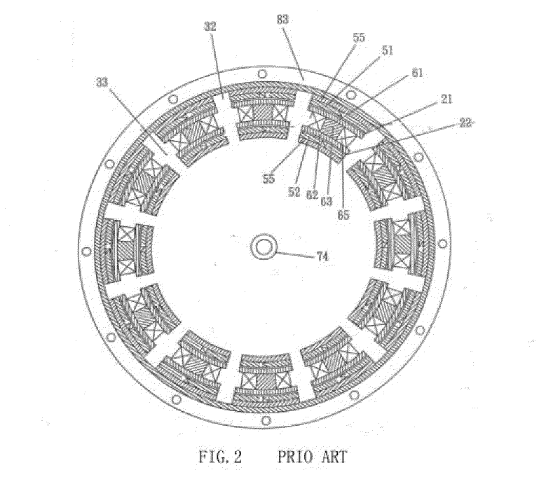

The FIG. 2 is the exemplary cutaway view for field magnet member as rotor and armature member as stator in rotating motor in China Patent Publication No. CN1897424, showing the structure of one of the phases in the first embodiment with illustrative examples. Inside the outer ring of the rotor 83, the rotor comprises a plurality of permanent magnet 51 or 52-containing magnetic assemblies arrayed in the movement direction, which are continuously and alternatively configured with magnetic field N/S in the circumferential direction in which the rotating shaft 74 surrounds, in order to form the annular rotor ring. Moreover, each permanent magnet forming the magnetic poles of the magnetic assemblies only shows a single magnetic field polarity on the surface facing the air gap and the magnetic field polarity thereof is opposite to the magnetic field polarity on the back surface of the permanent magnet combined to the inner side surface of the joint holder 55 of the magnetic assembly, so that each magnetic pole face of the permanent magnets as two magnetic poles only shows a single magnetic field polarity which is opposite to the magnetic field polarity of the other magnetic pole face, and the permanent magnets on the two magnetic poles of each magnetic assembly are separated from each other by a gap which is vertical to the movement direction. Accordingly, with the help of the joint holder 55 of the magnetic assembly made of magnetically conductive substance, magnetic flux is centralized at the ends of two magnetic poles of the magnetic assembly. The stator comprises a plurality of mutually magnetically-separated and coil 65-containing electromagnetic assemblies arrayed in the movement direction, each electromagnetic assembly includes paired poles 61, 62 connected with a magnetically conductive core part 63, when the coil on the electromagnetic assembly is excited, the magnetic flux thereof passes through the core part 63 and the paired poles 61, 62 and then penetrates through the air gaps 21, 22 of the stator and the rotor separated from each other to electromagnetically interact with two permanent magnets 51, 52 of the magnetic assembly of the rotor, wherein, two magnetic pole faces of each magnetic assembly are configured to be opposite to each other in the first direction vertical to the circumferential direction in which the rotating shaft surrounds, the first direction is exampled herein as radial direction, and each pole of the paired poles of the electromagnetic assembly is corresponding to one of two magnetic poles of the magnetic assembly in the movement direction with respective air gap separated. A plurality of electromagnetic assemblies, which form the stator ring in the circumferential direction in which the rotating shaft surrounds, is assembled to the stator by means of the joint holder made of non-magnetically conductive substance, so that the magnetic paths of the electromagnetic assemblies of each stator are independent of each other to thereby process conversion interference effect of magnetic flux between adjacent coils.

In the FIG. 2, the magnetic assemblies adjacent to each other in the movement direction have no ferromagnetic contact therebetween, and the interpolar spaces 32 of the magnetic assemblies adjacent to each other in the movement direction do not need to be completely identical in order to appropriately cooperate with the electromagnetic assemblies on the stator; in addition, the interpolar spaces 33 of the magnetic assemblies adjacent to each other in the movement direction do not need to be completely identical in order to reduce torque pulsation of the motor by means of appropriate arrangement, Such an arrangement can obtain more centralized magnetic flux distribution when the magnetic assemblies of the rotor are in cooperation with the electromagnetic assemblies on the stator, thus providing better motor characteristics. Accordingly, by means of magnetic flux centralization, utmost utilization of magnetic flux and minimization for magnetic flux loss and conversion interference effect, high-efficiency operation is provided when the motor is in high torque output.

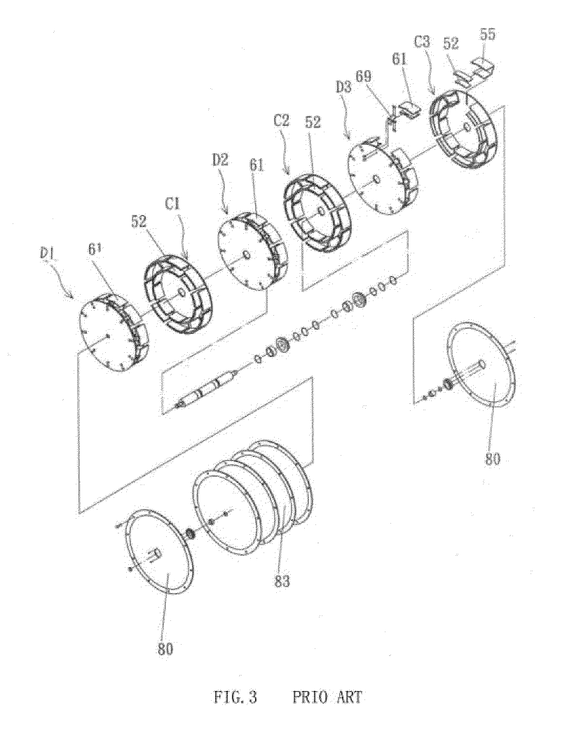

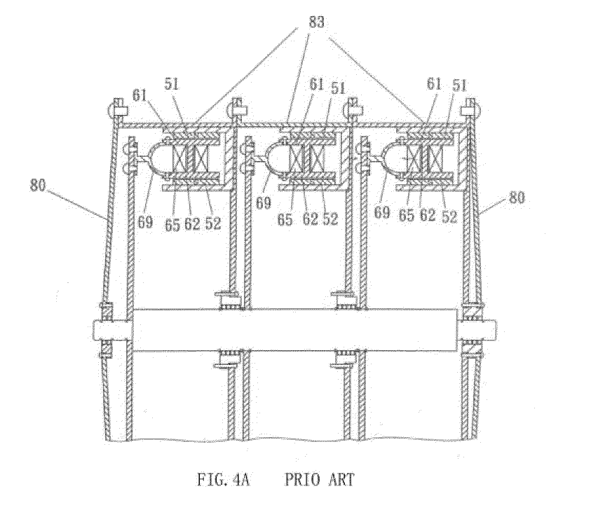

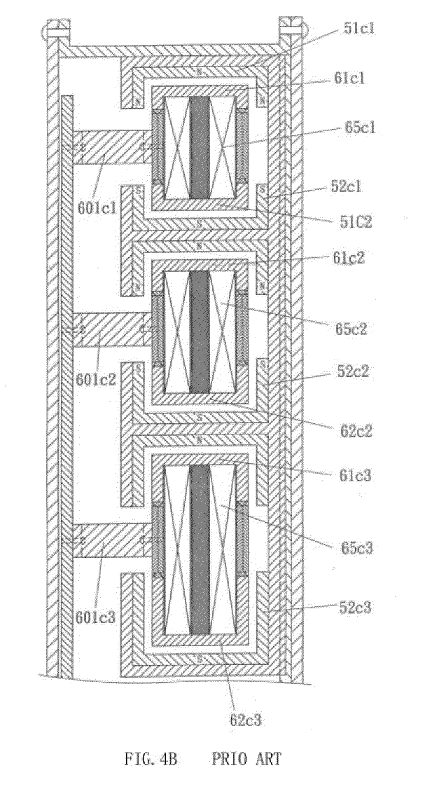

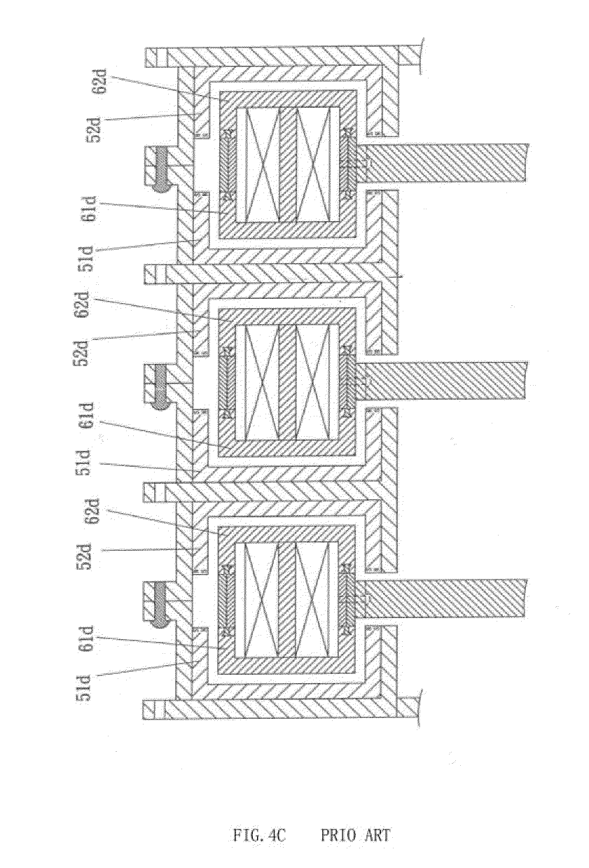

FIG. 3 is the three-dimensional exploded view resulted from axial arrangement of the combination of three motors in FIG. 2. FIG. 4A is the partially detailed sectional view for motors in FIG. 3, wherein, three outer rings of the rotor 83 are respectively combined with one of three field magnetic poles C1, C2, C3, and the three field magnetic poles C1, C2, C3 in the FIG. 3 are respectively corresponding to armature members D1, D2, D3 corresponding thereto; the field magnetic poles as the rotor are mutually combined by three outer rings of the rotor, are combined with the rotor discs 80 at two sides and penetrate through a bearing to be combined with the fixed shaft; the armature members as the stator are directly combined with the fixed shaft. On the stator, the electromagnetic assemblies form one part of the stator by the joint holder 69. Each electromagnetic assembly of the stator comprises paired poles 61, 62 connected with a magnetically conductive core part, and a coil 65 is formed on the core part of the electromagnetic assembly of the stator; two poles 61, 62 of the paired poles of a plurality of electromagnetic assemblies which form the stator ring in the circumferential direction in which the rotating shaft surrounds are respectively corresponding to the magnetic poles 51, 52 of two permanent magnets of the magnetic assembly of the rotor in a manner of being separated by respective air gaps. When the coils of the electromagnetic assemblies are excited, the magnetic flux thereof passes through the core part of the electromagnetic assembly and the paired poles 61, 62 and then penetrates through the air gaps of the stator and the rotor separated from each other to electromagnetically interact with two permanent magnets 51, 52 of the magnetic assembly.

A plurality of pole pairs is arrayed on the shaft as an organizational construction of the motor, which has been described in the above patent applications.

As a further improvement, the FIG. 4B is the partially detailed sectional view for a varied structure similar to FIG. 4A, which is the partially detailed sectional view resulted from radial arrangement of preferable embodiments of three rotating motors in China Patent Publication No. CN1897424. The magnetic flux is caused to be centralized on relatively large surface by increasing surface area of two magnetic poles of the magnetic assemblies passing through the air gap and the paired poles of the corresponding electromagnetic poles, therefore, magnetic flux distribution can also be improved to be more balanced. On the field magnet members as the rotor, the polar faces of two magnetic poles 51c1, 52c1, 51c2, 52c2, 51c3, 52c3 of each magnetic assembly are mutually configured to be opposite to each other in the first direction which is vertical to the circumferential direction in which the rotating shaft surrounds, the first direction is exampled herein as radial direction, and each magnetic pole face of two magnetic poles of each magnetic assembly includes corresponding pole faces in the second direction which is vertical to the circumferential direction in which the rotating shaft surrounds, and the second direction is approximately vertical to the first direction described hereinabove and is exampled herein as radial direction. On the stator, the electromagnetic assemblies comprising the coils 65c1, 65c2, 65c3 form one part of the stator by the stator fixing posts 601c1, 601c2, 601c3, so that each pole of the paired poles 61c1, 62c1, 61c2, 62c2, 61c3, 62c3 of the electromagnetic assemblies of the armature members as the stator is corresponding to one of two magnetic poles of the corresponding magnetic assemblies in a manner of being separated by respective air gaps in the movement direction. Accordingly, the magnetic poles of each permanent magnet of the magnetic assemblies each include three pole faces having identical magnetic field polarity, so that the pole faces of each magnetic pole of the magnetic assemblies interact with the corresponding pole faces of the corresponding poles of the paired poles of the stator in a manner of being separated by respective air gaps.

FIG. 4C is the partially detailed sectional view for the other varied structure similar to FIG. 4A, which is the partially detailed sectional view resulted from axial arrangement of the combination of preferable embodiments of three rotating motors in China Patent Publication No. CN101005229. Magnetic flux is caused to be centralized on relatively large surface by increasing surface area of two magnetic poles of the magnetic assemblies passing through the air gaps and the paired poles of the corresponding electromagnetic assemblies. On the field magnet members as the rotor, the pole faces of two magnetic poles 51d, 52d of each magnetic assembly are mutually configured to be opposite to each other in the first direction which is vertical to the circumferential direction in which the rotating shaft surrounds, the first direction is exampled herein as radial direction, and each magnetic pole face of two magnetic poles of each magnetic assembly includes corresponding pole faces in the second direction which is vertical to the circumferential direction in which the rotating shaft surrounds, and the second direction is approximately vertical to the first direction described hereinabove and is exampled herein as radial direction. Each pole of the paired poles 61d, 62d of the electromagnetic assemblies of the armature members as the stator is corresponding to one of two magnetic poles of the corresponding magnetic assemblies in a manner of being separated by respective air gaps in the movement direction. Accordingly, the magnetic poles of each permanent magnet of the magnetic assemblies each include three pole faces having identical magnetic field polarity, so that the pole faces of each magnetic pole of the magnetic assemblies interact with the corresponding pole faces of the corresponding poles of the paired poles of the stator in a manner of being separated by respective air gaps.

In the FIG. 4B and FIG. 4C, the paired poles of the electromagnetic assemblies include approximately identical pole face area, and two magnetic poles of the magnetic assemblies also include approximately identical pole face area. Although by means of the appropriate arrangement of magnetically conductive material, the pole face area of the paired poles of the stator having the electromagnetic assemblies with approximately identical pole face area is not always identical to the pole face area of the two magnetic poles of the rotor having the magnetic assemblies with approximately identical pole face area, the pole face area of two poles of the paired poles of one electromagnetic assembly of the stator is approximately identical to the pole face area of two magnetic poles of one magnetic assembly of the rotor, which can cause magnetic flux distribution on two poles of the electromagnetic assemblies of the stator and on two magnetic poles of the magnetic assemblies of the rotor and can achieve further geometrically balanced requirement of the motor owing to balance effect.

As the motor obtains better geometrical balance in the space and surface area of two magnetic poles of the magnetic assemblies passing through the air gaps and the paired poles of the corresponding electromagnetic assemblies, such an arrangement is advantageous for being used in the environment in which additional space and weight are hardly increased and for resulting in further improvement for flexible and safe operational characteristics of the motor.

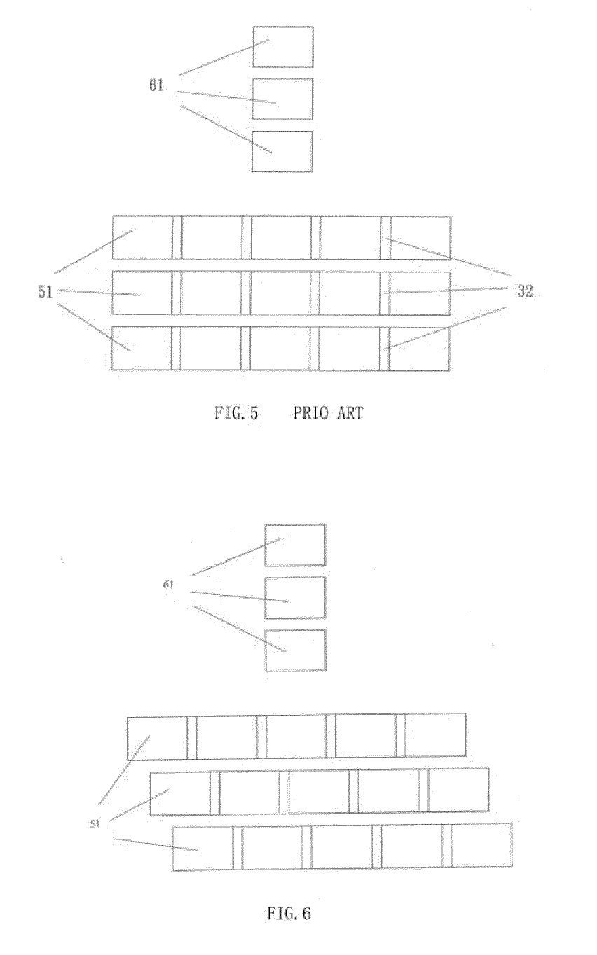

FIG. 5 is a schematic diagram for the partial planar layout of magnetic pole face of one of two magnetic poles of the magnetic assembly of the field magnet member of the motor and corresponding pole face of the paired poles of the electromagnetic assembly of the corresponding armature member, in accordance with FIG. 4A. In the FIG. 5, one of the magnetic pole faces of the magnetic assemblies and corresponding pole face of the corresponding electromagnetic assemblies are taken as examples; the upper half part of the drawing shows the planar layout of the pole face 61 of one of the paired poles of a group of three adjacent electromagnetic assemblies in the movement direction; and the lower half part of the drawing shows the planar layout of the pole face 51 of the permanent magnet of five groups of three adjacent magnetic assemblies in the movement direction, wherein, the magnetic assemblies adjacent to each other in the movement direction are separated from each other by the space 32. In the FIG. 5, five adjacent magnetic assemblies which arrayed from left to right can be arranged, as the example, in a manner that: the pole face polarity of the lower magnetic pole is N, S, N, S and N, the pole face polarity of the middle magnetic pole is N, S, N, S and N and the pole face polarity of the upper magnetic pole is N, S, N, S and N (not shown in the FIG. 5). In the FIG. 5, the pole faces of the paired poles of the upper electromagnetic assemblies are corresponding to the pole faces of the permanent magnets of the upper magnetic assemblies, the pole faces of the paired poles of the middle electromagnetic assemblies are corresponding to the pole faces of the permanent magnets of the middle magnetic assemblies, and the pole faces of the paired poles of the lower electromagnetic assemblies are corresponding to the pole faces of the permanent magnets of the lower magnetic assemblies, and the electromagnetic assemblies are magnetically isolated from each other. Such a structure for single-phase motor can cause the situation that, when the pole face of certain electromagnet faces the magnetic pole face of the magnet of certain magnetic assembly, the pole face of each other electromagnet faces the magnetic pole face of the magnet of the magnetic assembly of one of the permanent magnets for sure; accordingly, regardless of the presence of excitation current in the coils of the electromagnetic assemblies of the motor, the acting force between the electromagnetic assemblies and the magnetic assemblies are inevitably vertical to the movement direction without generating the acting force applied to the movement direction. In order to cause the motor to drive the armature members as the rotor to move, in the movement direction, a sequential multiple groups of electromagnetic assemblies need to be arranged to form the structure of phase motor and electromagnets in the movement direction are sequentially excited to control the rotor to move in a predetermined direction; however, when the motor is in operation, the detent torque of this structure for the rotating motor is accumulated with respect to a motor as the permanent magnets causes additional detent torque through the electromagnets; in addition, the motor is compelled to leave many spaces in the movement direction to arrange necessary electromagnets, thus causing many of the spaces of the motor in the movement direction are occupied; this condition is disadvantageous for simultaneously arranging a plurality of serially-connected and independently-moving individuals in the spaces of the motor in the movement direction.

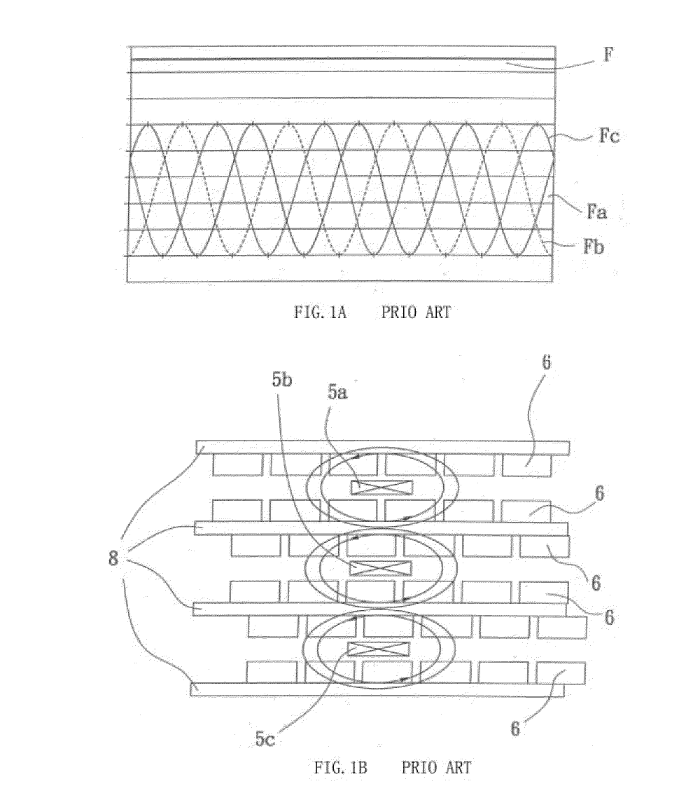

FIG. 6 is a schematic diagram for the partial planar layout of the surface of magnetic pole face of one of two magnetic poles of the magnetic assembly of the field magnet member of the multi-phase rotating motor and corresponding pole face of the paired poles of the electromagnetic assembly of the corresponding armature member, in accordance with the first embodiment of the present invention, wherein, each motor in the second drawing is one of the phases of the three-phase rotating motor in accordance with the first embodiment. In order to cause only one group of armature members as the rotor to smoothly move on three axially adjacent electromagnetic assemblies, the FIG. 6 shows how the magnetic pole face 51 of the magnetic assemblies and the corresponding pole face 61 of the corresponding electromagnetic assemblies change structural arrangement of the magnetic assemblies and the corresponding electromagnetic assemblies in the FIG. 5, so as to be arranged in the multi-phase rotating motor in accordance with the present invention to thereby realize effect described in the FIG. 1A. In the FIG. 6, a multi-phase rotating motor comprises a field magnet member and an armature member. The field magnet member includes three magnetic tracks, in each of which the magnetic assemblies comprising two magnetic poles are configured to form an annular ring in the circumferential direction in which the rotating shaft surrounds, and each magnetic pole face of two magnetic poles of each magnetic assembly only shows a single magnetic polarity and the magnetic field polarity is opposite to the magnetic field polarity of the other magnetic pole face; multi-phase units included by armature member form in a manner that each-phase unit comprises at least one electromagnetic assembly including the paired poles, and the each-phase unit is magnetically isolated from other phase units and each pole of each magnetic assembly comprises respective pole face, wherein, the electromagnetic assemblies of the each-phase unit of the armature member is coaxially configured with one of the magnetic tracks of the field magnet member in the circumferential direction in which the rotating shaft surrounds, and two magnetic pole faces of each magnetic assembly are configured to be opposite to each other in the first direction vertical to the circumferential direction in which the rotating shaft surrounds, wherein, the first direction is exampled herein as radial direction, and each pole face of the electromagnetic assembly of the each-phase unit is separated by air gap from one of magnetic pole faces of the magnetic assembly of the coaxially configured magnetic track. The permanent magnets of each magnetic assembly are integrally combined by means of a connection part made of magnetically conductive material, so that the permanent magnets forming the magnetic poles of the magnetic assemblies only show a single magnetic field polarity on the surface facing the air gap and the magnetic field polarity is opposite to the magnetic field polarity on the back surface of the permanent magnet combined to the connection part of the magnetic assemblies. The permanent magnets on two magnetic poles of each magnetic assembly are separated from each other by the gap vertical to the movement direction, each magnetic poles of the magnetic assemblies in each magnetic track of the field magnet member and adjacent magnetic poles of the adjacent magnetic assemblies arrayed in the circumferential direction in which the rotating shaft surrounds are continuously and alternatively configured with magnetic pole polarity in the circumferential direction in which the rotating shaft surrounds. In addition, the electromagnetic assembly includes coils and the magnetically conductive connection part, when the coils of the electromagnetic assemblies are subjected to current excitation, each pole face of the electromagnetic assemblies generates a single magnetic field polarity and the magnetic field polarities generated on the adjacent pole faces of the electromagnetic assemblies are caused to be opposite to each other, and when the currents in the coils reverse, the magnetic field polarities on each pole face of the electromagnetic assemblies reverse therewith. The field magnet members as the stator are mutually offset in a manner that the magnetic pole faces of three adjacent magnetic assemblies are arranged in a direction vertical to the movement direction. By means of the difference between the magnetic track corresponding to the electromagnetic assemblies of the each-phase unit and the magnetic track corresponding to the electromagnetic assemblies of other phase unit and by adding three-phase current into a group of coils of three axially adjacent electromagnetic assemblies, and the current waveform of each phase is a sine waveform, so that the motor obtain combined force which is basically a fixed value, and with only a group of three adjacent electromagnetic assemblies, the armature members and the field magnet members can be controlled in the movement direction to relatively move in a predetermined direction. This offset can reduce interference of detent torque to a certain extent, but the permanent magnets cause additional detent torque through the electromagnets, which still interferes with the operation of the motor.

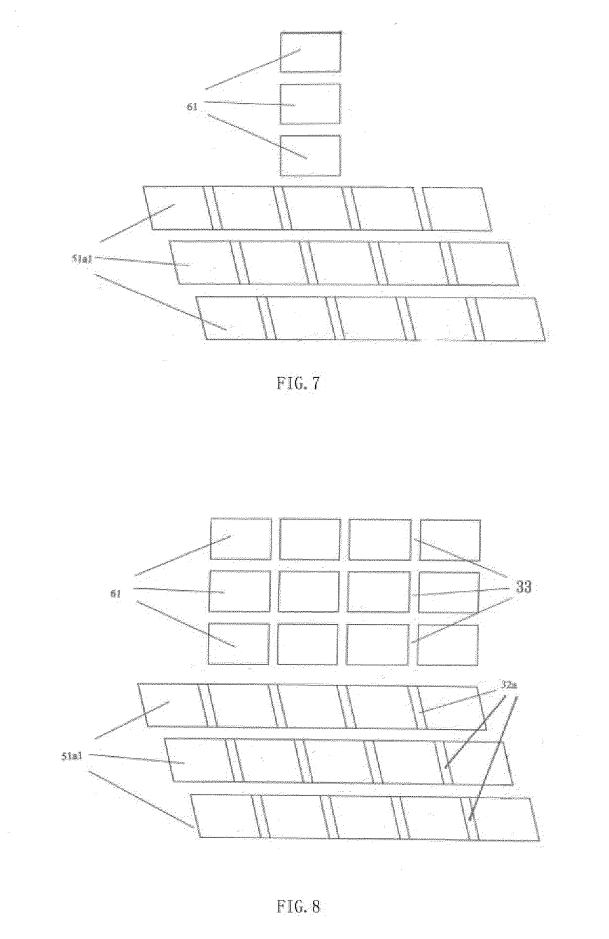

FIG. 7 is the schematic diagram for the partial planar layout of the surface of the magnetic pole face of one of two magnetic poles of the magnetic assembly of the field magnet member of the multi-phase rotating motor and corresponding pole face of the paired poles of the electromagnetic assembly of the corresponding armature member, in accordance with the second embodiment of the present invention. FIG. 8 is the schematic diagram for the partial planar layout of one varied structure, which is similar to the schematic diagram for the planar layout in FIG. 7, in accordance with the third embodiment of the present invention. The upper half part of the FIG. 8 shows three groups of each-phase units, 4 electromagnetic assemblies of which are magnetically isolated from each other, and there are provided the interpolate space 33 between the adjacent electromagnetic assemblies in the circumferential direction in which the rotating shaft surrounds; the lower half part of the FIG. 8 shows three groups of magnetic tracks, 5 adjacent electromagnetic assemblies of which are separated from each other by the interpolate space 32a in the circumferential direction in which the rotating shaft surrounds. 5 adjacent electromagnetic assemblies of each of three groups of magnetic tracks arrayed from left to right, shown at the lower half part of the FIG. 8, can be arranged in a manner that: the pole face polarity of the lower magnetic pole is N, S, N, S and N, the pole face polarity of the middle magnetic pole is N, S, N, S and N and the pole face polarity of the upper magnetic pole is N, S, N, S and N (not shown in the FIG. 8). The magnetic pole faces 51a1 of three axially adjacent magnetic assemblies shown in the FIG. 7 and FIG. 8 are not only arranged to be axially mutually offset, but also include oblique relation with the corresponding pole faces 61 of the corresponding electromagnetic assemblies; such an oblique relation can inhibit change rate of the detent torque to further reduce interference of the detent torque to the operation of the motor.

In the FIG. 7 and FIG. 8, when the edge of the pole face of the electromagnet gets close to or gets away from the edge of the pole face of the permanent magnet, as the interacted edges of the pole faces are mutually obliquely related to each other, variation of additional detent torque applied to the electromagnet and the permanent magnet does not change suddenly, as a result, pulsation of the motor caused by the additional detent torque is reduced considerably; by means of this oblique arrangement, that the pole face of each pole of the magnetic assemblies is geometrically different in surface from the pole face of the corresponding magnetic pole of the corresponding magnetic assemblies with the air gap separated therebetween, can smooth the variation of the additional detent torque of the electromagnet and the permanent magnet, and the pole faces of the magnetic poles of three adjacent magnetic assemblies are mutually offset in the direction vertical to the movement direction in cooperation with three adjacent electromagnetic assemblies, which can cause the detent torques to be mutually cancelled to further stabilize the variation of the detent torque.

According to the first and the second embodiments, each-phase units of the three-phase rotating motor each include an electromagnetic assembly, and a relative movement is caused between the armature member and the field magnet member by flowing an alternating current with preset offset on the electromagnetic assembly of the each-phase unit which is coaxially configured with one of the magnetic tracks of the field magnet member, wherein, the alternating sine-wave current cycling in the coils of the electromagnetic assembly of the each-phase unit of the three-phase rotating motor has a 120-degree phase offset with respect to the alternating sine-wave current cycling in the coils of the electromagnetic assembly of the adjacent phase unit, so that the three-phase rotating motor obtains a combined force which is basically a fixed value, to thereby realize the effect described in the fifth drawing. Three-phase is herein taken as an example. This condition is advantageous for simultaneously arranging a plurality of serially-connected and independently-moving individuals in the spaces of the motor in the movement direction.

FIG. 9 is the schematic diagram for the partial planar layout of the other varied structure, which is similar to the schematic diagram for the planar layout in FIG. 8, in accordance with the fourth embodiment of the present invention. The FIG. 9 shows that the pole faces 61 of three adjacent electromagnetic assemblies are arranged in the direction vertical to the movement direction to be mutually offset; while the pole faces 51a1 of the magnetic poles of three adjacent magnetic assemblies are arrayed in the direction vertical to the movement direction and are obliquely related to corresponding pole faces of the corresponding electromagnetic assemblies.

In the third and the fourth embodiments, the coils of each electromagnetic assembly in each magnetic track can be serially, parallely connected, or respectively excited in accordance with the requirements, so that currents cycling on the coils of each electromagnetic assembly in the same magnetic track are phase currents with the same phase; only when the coils of adjacent electromagnetic assemblies arrayed in the circumferential direction in which the rotating shaft surrounds are excited with same-phase currents, what is opposite is not only the magnetic field polarity generated on adjacent pole faces of the electromagnetic assemblies, but also the magnetic field polarity generated along adjacent magnetic pole faces in the circumferential direction in which the rotating shaft surrounds by the adjacent electromagnetic assemblies arrayed in the circumferential direction in which the rotating shaft surrounds, so that the coils can be electromagnetically interacted with the corresponding magnetic poles which are continuously and alternatively configured with magnetic pole polarity N/S in the circumferential direction in which the rotating shaft surrounds in the corresponding track. And the number of the electromagnetic assemblies of the each-phase units can arrange the number at least more than one electromagnetic assembly in accordance with the requirements.

In the third and the fourth embodiments, the space 33 between axially adjacent electromagnetic assemblies causes the adjacent electromagnetic assemblies to be contacted with each other in a non-ferromagnetic manner, thus reducing conversion interference effect of the magnetic flux between adjacent coils; and the space 32a between the magnetic assemblies adjacent in the movement direction causes the adjacent magnetic assemblies to be magnetically isolated from each other, so that the magnetic flux of the magnetic pole can be distributed more flatly, wherein, multiple groups of paired pole-containing electromagnetic assemblies arrayed in the movement direction are magnetically isolated from each other, and the magnetic track in which the coil-containing electromagnetic assemblies of each phase move is different from the magnetic track in which the coil-containing electromagnetic assemblies of other phases move, so that the coil-containing electromagnetic assemblies of each phase is not interacted with all the magnetic assemblies. The above structure controls the rotor to move in a predetermined direction by axially arranging a sequential electromagnetic assembly and by sequentially exciting electromagnets which are axially arrayed. Such an arrangement can provide higher torque output by increasing more parallel air gaps on condition of limited length of the movement direction; or more electromagnetic assemblies are arranged in the movement direction space on condition of identical volume to more effectively utilize movement spaces of the motor in the circumferential direction in which the rotating shaft surrounds, thus providing higher torque output. Accordingly, the movement direction space of the motor can be utilized more effectively. The third and the fourth embodiments result in identical output characteristics under the same input.

FIG. 10 is the schematic diagram for the partial planar layout of one varied structure, which is similar to the schematic diagram for the planar layout in FIG. 7, in accordance with the fifth embodiment of the present invention. The pole faces of the paired poles of the electromagnetic assemblies in the second embodiment are changed into this geometric configuration mode in the fifth embodiment, serving as an alternative to smooth and change reluctance change rate between the electromagnetic assemblies and the magnetic assemblies. As shown in the FIG. 10, a pole face 61a1 of the paired poles of the electromagnetic assemblies and a pole face 51 of two magnetic poles of the magnetic assemblies have separate identical geometric configuration mode on the surface thereof facing the air gaps. In the fifth embodiment, each pole face of the electromagnetic assemblies is geometrically different in surface from the corresponding magnetic pole face of the corresponding magnetic assemblies with the air gap separated therebetween, so that two pole faces of two magnetic poles of the magnetic assemblies and the corresponding pole faces of the corresponding electromagnetic assemblies have the oblique relation which is different from that of the embodiments described hereinabove. This change of the oblique relation in different situation still has the efficiency of smoothing change rate of the detent torque between the electromagnetic assemblies and the magnetic assemblies and has different change rate of the detent torque compared with the embodiments described hereinabove.

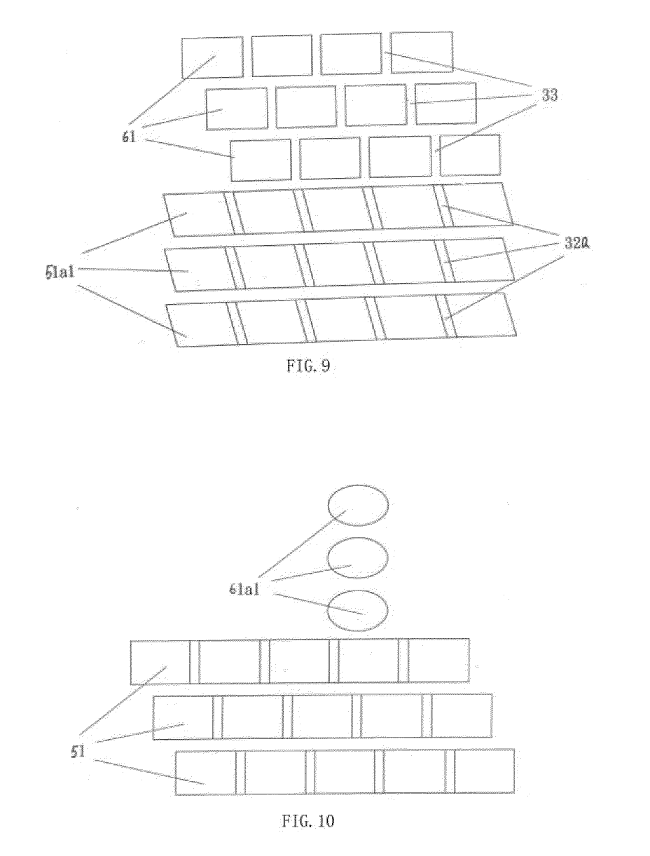

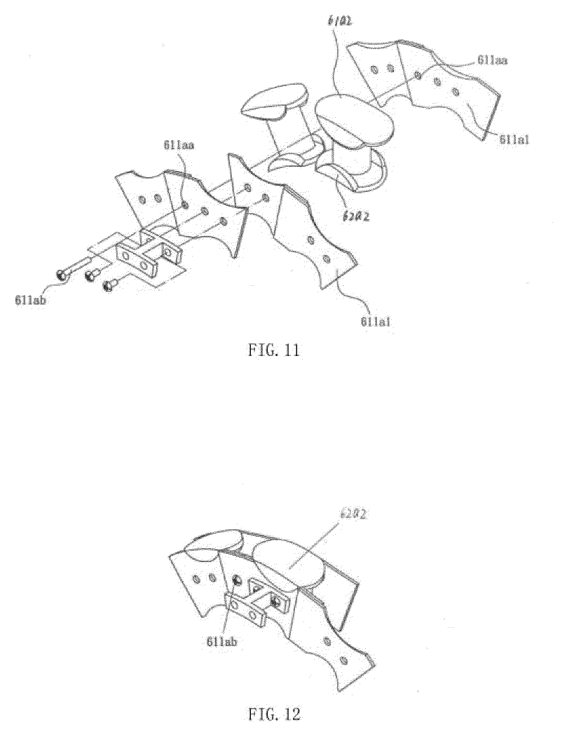

FIG. 11 is the partial three-dimensional exploded view for an each-phase unit of one of the phases in the armature member of the three-phase rotating motor, in accordance with the sixth embodiment of the present invention. FIG. 12 is the constitutional diagram of partial three-dimensional exploded view for an each-phase unit of one of the phases in the armature member with structure in FIG. 11. In the sixth embodiment, the rotating motor just as that in the FIG. 4B or FIG. 4C causes magnetic flux to be centralized on relatively larger surface by increasing pole face area of two magnetic poles of the magnetic assemblies passing through the air gaps and the paired poles of the corresponding electromagnetic assemblies; therefore, each magnetic pole face of two magnetic poles of each magnetic assemble additionally includes the corresponding pole face (not shown) in the second direction vertical to the circumferential direction in which the rotating shaft surrounds, and the second direction is exampled herein as axial direction, and each pole face of the paired poles of the electromagnetic assemblies of the each-phase unit additionally includes the corresponding pole face in the second direction vertical to the circumferential direction in which the rotating shaft surrounds, and the second direction is exampled herein as axial direction, so that each pole face of the paired poles of the electromagnetic assemblies of the each-phase unit is axially separated from the corresponding magnetic pole face of two magnetic poles of the corresponding magnetic assemblies by the air gaps. In addition, the arrangement in the sixth embodiment is similar to that in the third embodiment, the field magnet members in the sixth embodiment are axially arranged to be mutually offset with the magnetic pole faces of three adjacent magnetic assemblies; furthermore, multiple groups of electromagnetic assemblies having the paired poles, which are arrayed in the circumferential direction in which the rotating shaft surround, are magnetically isolated from each other, in order to have different magnetic tracks for movement with the electromagnetic assemblies of other phases by means of the magnetic track for the movement of the electromagnetic assemblies of each phase. The three-phase rotating motor is coaxially configured with one of the magnetic tracks, wherein, the alternating sine-wave current cycling in the coils of the electromagnetic assemblies of the each-phase unit has a 120-degree phase offset with respect to the alternating sine-wave current cycling in the coils of the electromagnetic assemblies of the adjacent phase unit, so that the three-phase rotating motor obtains a combined force which is basically a fixed value, to thereby result in a relative movement between the field magnet members and the armature members. In order to cooperate with the magnetic pole faces of the magnetic assemblies, the pole faces of each elliptic pole 61a2, 62a2 of the paired poles of the electromagnetic assemblies of the armature members are configured to be opposite to each other in the first direction vertical to the circumferential direction in which the rotating shaft surrounds, the first direction is exampled herein as radial direction, and the pole faces of each elliptic pole has, in the second direction vertical to the circumferential direction in which the rotating shaft surrounds, the pole faces corresponding to the magnetic pole faces of the corresponding magnetic assemblies, and the second direction is approximately vertical to the first direction and is exampled herein as radial direction; the circular arc face of the side of the pole face of the electromagnetic assemblies in the radial direction is provided with an inclined plane for the compatible joint between the circular arc face and the fixed plates 611a1 made of non-magnetically conductive material at the time of assembly. Each fixed plate 611a1 can be composed of two identical components, each of which is approximately concentric circular arc and two sides of which are provided with elongated sheets with curved circular arc, ends of two identical elongated sheets are jointed and the hole 611aa at the joint of the elongated sheets can be taken as the fact that two axially corresponding fixed plates are fixed with each other in a traditional fixation manner. The fixed assembly 611ab is the result of such a representation. While the assembly, the inclined planes with curved circular arc faces at the two sides of each elongated sheet are cooperative with the inclined planes with curved circular arcs at the sides of the pole faces of the electromagnetic assemblies in the radial direction. The hole on the fixed plate can be taken as the mutual joint between two adjacent fixed plates, and with the help of the supporting post, the electromagnetic assemblies are configured in the movement direction to form the armature members, which is exampled in the FIG. 11 and FIG. 12.

In the sixth embodiment, magnetic flux are caused to be centralized on relatively larger surface by increasing additional pole face area of two magnetic poles of the field magnet members passing through the air gaps and the paired poles of the corresponding armature members, in order to further improve high output capability of the rotating motor; and meanwhile, the magnetic pole faces of two permanent magnets of the magnetic assemblies are caused to have pole face area with the same size by increasing additional pole face of the multi-phase rotating motor, and two pole face areas of the paired poles of the electromagnetic assemblies are the same, which provides additional structural advantages. Such an improvement causes the motor to be capable of obtaining two poles with equalized magnetic flux distribution and also obtaining geometrically structural balance of the motor.

Various embodiments described hereinabove can be exampled as the sixth embodiment, additional increase of the surface area of the magnetic poles of the field magnet members passing through the air gaps and the corresponding armature members by additionally increasing the pole face of the magnetic assemblies passing through the air gaps in the second direction vertical to the circumferential direction in which the rotating shaft surrounds and the pole face of the corresponding electromagnetic assemblies, in order to cause the magnetic flux to be centralized on relatively larger surface to thereby further improve high output capability of the rotating motor, wherein, the second direction is not only vertical to the circumferential direction in which the rotating shaft surrounds, but also to the first direction.

In the examples of the third, the fourth and the sixth embodiments, the pole faces of the electromagnetic assemblies with the same size and the pole faces of the magnetic assemblies with the same size tend to move the rotors to a balanced position under the action of the detent torque, however, multiple groups of three axially adjacent electromagnetic assemblies enlarge the disadvantageous impact caused by the detent torque. However, on condition of unchanged input three-phase current, in order to minimize reluctance between the electromagnetic assemblies and the magnetic assemblies, the pole faces of the magnetic assemblies corresponding with respect to each other have different oblique relations by arranging the pole faces of each group of three axially adjacent electromagnetic assemblies to have the same surface geometric shape and arranging the pole faces of each group of three axially adjacent electromagnetic assemblies to have the surface geometric shape different from that of the pole faces of other groups of three axially adjacent electromagnetic assemblies; and the detent torque (not shown) increased due to the multiple groups of electromagnetic assemblies are reduced by means of causing different change rate of the detent torque by different oblique relations.

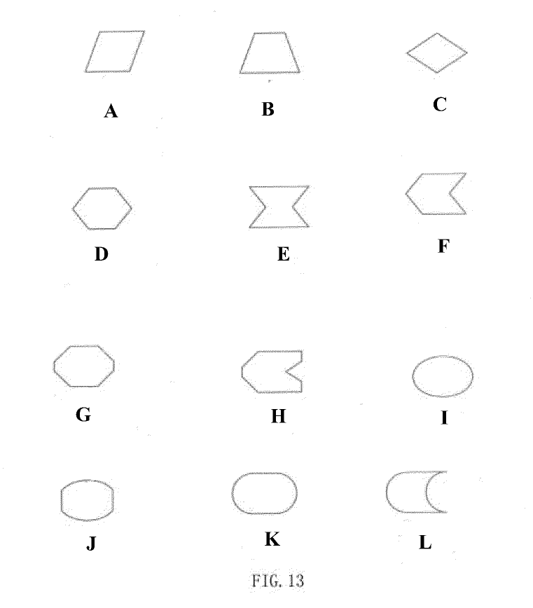

FIG. 13A to FIG. 13L are embodiments of planar layout of various configuration of paired poles of the electromagnetic assembly and pole face parts of two magnetic poles of the magnetic assembly in the multi-phase rotating motor, in accordance with the present invention. In the drawings, various geometric configuration modes with different shapes can be taken as the selection for the surface geometric shape of the pole faces of the electromagnetic assemblies and the magnetic assemblies, which is similar to the example of mutual replacement between the fifth embodiment in the FIG. 10 and the seventh embodiment in the FIG. 7. In the FIG. 13A to the FIG. 13L, the pole faces of various geometric configuration modes with different shapes can provide different oblique relations between the electromagnetic assemblies and the magnetic assemblies; by means of appropriate matching, desired reluctance change rate between the electromagnetic assemblies and the magnetic assemblies is obtained. The geometric configuration modes with different shapes shown in the FIG. 13A to the FIG. 13L can be made of powdered soft iron-core material, the geometric configuration modes with different shapes shown in the drawings are only examples, not limitations.

No ferromagnetic contact is present between the electromagnetic assemblies adjacent in the circumferential direction in which the rotating shaft surrounds in various embodiments prior to the invention, but partial structures of various embodiments of the present invention can be replaced in order to result in the ferromagnetic contact between the electromagnetic assemblies adjacent in the circumferential direction in which the rotating shaft surrounds, and this variation is still an example of various embodiments of the present invention. Varying partial structures of the three-phase rotating motor described in the third, the fourth or the sixth embodiments herein are taken as exemplary description.

In the examples of the varied structure of the three-phase rotating motor described hereinabove in the third, the fourth or the sixth embodiments of the invention, each electromagnetic assembly of the each-phase unit of the armature members is respectively fixed by the support structure composed of magnetically conductive material, so that the electromagnetic assemblies adjacent in the circumferential direction in which the rotating shaft surrounds have ferromagnetic contact therebetween and the half number of the electromagnetic assemblies of the armature members is removed, and the magnetic tracks are averagely assigned so that the electromagnetic assemblies adjacent in the circumferential direction in which the rotating shaft surrounds can be removed with one electromagnetic assembly separated, thus increasing space size between the electromagnetic assemblies adjacent in the circumferential direction in which the rotating shaft surrounds by the spacing of one pole face (not shown). In addition, the field magnet members exampled in this varied structure are still the same as the field magnet members of the three-phase rotating motor described hereinabove in the third, the fourth or the sixth embodiments; therefore, the electromagnetic assemblies of the each-phase unit of the armature members in this varied structure are coaxially configured with one of the magnetic tracks of the field magnet members, and each pole face of the electromagnetic assemblies of the each-phase unit is separated by the air gaps from one of the magnetic pole faces of the magnetic assemblies of the coaxially configured magnetic tracks. Further more, the coils of each magnetic assembly in each magnetic track can be considered requiring serial connection, parallel connection or be considered requiring respective excitation so that the current cycling in the coils of each electromagnetic assembly of the same magnetic track is the phase current with the same phase; as a result, when the coils of the adjacent electromagnetic assemblies arrayed in the circumferential direction in which the rotating shaft surrounds are excited with in-phase current, magnetic field polarities generated by two pole faces of the paired poles of the electromagnetic assemblies generate are opposite to each other, and the electromagnetic assemblies arrayed in the circumferential direction in which the rotating shaft surrounds have the same magnetic field polarity generated by the adjacent magnetic pole faces thereof in the circumferential direction in which the rotating shaft surrounds. Accordingly, the each-phase unit of the armature members of the three-phase rotating motor is magnetically isolated from the other phase units, and the magnetic tracks to which the electromagnetic assemblies of the each-phase unit are corresponding are different from those to which the electromagnetic assemblies of other phase units are corresponding, and as the alternating sine-wave current cycling in the coils of the electromagnetic assemblies of the each-phase unit has a 120-degree phase offset with respect to the alternating sine-wave current cycling in the coils of the electromagnetic assembly of the adjacent phase unit, the armature members and the field magnet members are controlled to implement a relative movement in a predetermined direction in the circumferential direction in which the rotating shaft surrounds.

Other embodiments of the present invention improve the above three-phase rotating motor varying the partial structures of the third, the fourth or the sixth embodiments. The support structure of each electromagnetic assembly of the each-phase unit of the armature members is varied to be made of non-magnetically conductive material. This variation causes the three-phase rotating motor to have the space with the electromagnetic assemblies adjacent in the circumferential direction in which the rotating shaft surrounds by respectively fixing each electromagnetic assemblies by the support structure made of non-magnetically conductive material, so that no ferromagnetic contact is present between the electromagnetic assemblies adjacent in the circumferential direction in which the rotating shaft surrounds, in order to reduce conversion interference effect of magnetic flux between adjacent coils; accordingly, even though the coils of certain electromagnetic assembly is in failure, the interference of disadvantage impact thereof can be limited due to magnetic isolation between the electromagnetic assemblies.

Accordingly, as the examples of the above embodiments, the method provided by the invention can provide higher torque output, or simultaneously arranging more independently-moving individuals by increasing more parallel air gaps under the limited length of the movement direction. The appropriate number of the units can even be selected based on a group of three electromagnetic assemblies as a unit in accordance with the requirement, so as to meet the output requirement.

In addition, in various multi-phase rotating motors taking the three-phase rotating motor as examples of the embodiment prior to the present invention, the magnetic assemblies adjacent in the circumferential direction in which the rotating shaft surrounds are magnetically isolate, however, partial structures of various embodiments of the present invention can be replaced so that the magnetic assemblies adjacent in the circumferential direction in which the rotating shaft surrounds are non-magnetically isolate. For example, the casing of the three-phase rotating motor, which is used as the fixed magnetic assembly, is alternatively made of magnetically conductive material, or the space between the magnetic assemblies adjacent in the circumferential direction in which the rotating shaft surrounds is removed. Moreover, the connection part of the magnetic assemblies of the three-phase rotating motor, which is made of magnetically conductive material, can also be alternatively made of non-magnetically conductive material. The above various variations have disadvantageous impact on magnetic flux centralization of the magnetic assemblies; however, the operation and the control of these multi-phase rotating motors still are the same as those of previous embodiments and still belong to one of various embodiments of the present invention, and available operation can be obtained.

When the present invention is embodied, to either of the magnetic assembly or the electromagnetic assembly, the assemblies thereof can be manufactured in size in the normalized manner to facilitate simplifying the manufacturing. In addition, as the further improvement, in various embodiments of the present invention, the magnetic assemblies can be integrated with the permanent magnets by means of the connection part made of magnetically conductive material, and the casing of the multi-phase rotating motor, which is used as the fixed magnetic assembly, is made of magnetically conductive material, so that no ferromagnetic contact is present between the magnetic assemblies of the field magnet members; accordingly, flatter magnetic flux distribution can be provided on the magnetic poles of the magnetic assemblies. In addition, the electromagnetic assemblies are respectively fixed by the support structure made of non-magnetically conductive material, so that the magnetic tracks between the electromagnetic assemblies of each stator is substantially independent of each other in order to reduce conversion interference effect of magnetic flux as far as possible. Therefore, the multi-phase rotating motor of the present invention obtains not only magnetic flux centralization, but also minimization for magnetic flux loss and interference effect in motor characteristics.

Accordingly, the multi-phase rotating motor of the present invention can reduce pulsation caused by the detent torque to the output torque and can, by means of the arrangement of multi-phase units of the armature members and difference between the magnetic track corresponding to the each-phase unit and the magnetic track corresponding to other phase units, cause the motor to improve high torque capability of the motor on condition of limited movement direction space due to the increased effective air gap surface area of the magnetic assemblies of the field magnet members and the electromagnet assemblies of the corresponding armature members, and the benefit that high torque output is provided or, in accordance with the requirement, more serially-connected and independently-moving individuals are arranged, is obtained, in fact, the multi-phase rotating motor is easy for manipulation.

Various implementation forms described above illustrate the invention as an example, but the invention is not limited by equivalent implementation forms. The multi-phase units of the armature members exampled in the invention are surrounded by the annular rings of the outside field magnet members, but these structures can be reversely disposed so that the annular rings of the field magnet members are surrounded by the multi-phase units of the armature members. In addition, the invention can also has other different implementation forms, such as using a plurality of coils to replace single coil; increasing more parallel phase units with only small number of the phase units; unbalanced mutually-offset phase of the phase current, like mutual offset of the three-phase unit at a 120-degree phase; the phase current with in-phase current cycling in the coils of each electromagnetic assembly in the same magnetic track but with uncertainly same size; and the like. In this disclosure, a few various examples of the invention are only shown and described. The invention can be applied to various other combinations and environments and can be varied or modified within the scope without going beyond the concept of the invention similar to the above description.

1. A multi-phase rotating motor, comprising:
a field magnet member including two or more than two magnetic tracks, wherein, each said magnetic track is a magnetic assembly comprising two magnetic poles, which is configured to form an annular ring in a circumferential direction in which a rotating shaft surrounds, and each magnetic pole face of two magnetic poles of each magnetic assembly only shows a single magnetic field polarity and the magnetic field polarity is opposite to the magnetic field polarity of the other magnetic pole face;
an armature member including a multi-phase unit formed in a manner that an each-phase unit at least comprises an electromagnetic assembly comprising paired poles, wherein, the each-phase unit is magnetically isolated from other phase units and each pole of each of the said electromagnetic assembly comprises respective pole face;
wherein, the said electromagnetic assembly of the each-phase unit of the said armature member is coaxially configured with one of the said magnetic tracks of the said field magnet member in the circumferential direction in which the rotating shaft surrounds, and two magnetic pole faces of each magnetic assembly are configured to be opposite to each other in a first direction vertical to the circumferential direction in which the rotating shaft surrounds, and each pole face of the said electromagnetic assembly of the each-phase unit is separated by an air gap from one of the said magnetic pole faces of the magnetic assembly of the coaxially-configured magnetic tracks;
characterized in that: the said magnetic track to which the said electromagnetic assembly of the each-phase unit are corresponding is different from the said magnetic track to which the said electromagnetic assembly of other phase units; the magnetic assembly of different magnetic tracks are mutually dislocated; adjacent magnetic assembly inside the said magnetic track have equal polar spacing in the circumferential direction in which the rotating shaft surrounds; and, a relative movement between the said armature member and the said field magnet member is caused by flowing an alternating current with preset offset on the said electromagnetic assembly of the each-phase unit which is coaxially configured with one of the said magnetic tracks of the said field magnet member.

2. The multi-phase rotating motor according to claim 1, characterized in that: each pole face of the said electromagnetic assembly is different in surface geometric shape from the corresponding magnetic pole face of the corresponding magnetic assembly with the air gap separated therebetween.

3. The multi-phase rotating motor according to claim 1, characterized in that: the said electromagnetic assembly have coils and a magnetically conductive connection part, when the coils of the said electromagnetic assembly are subjected to current excitation, a single magnetic field polarity is generated on each pole face of the said electromagnetic assembly and opposite magnetic field polarities are generated on the adjacent pole faces of the said electromagnetic assembly, and when the currents passing through the coils reverse, the magnetic field polarity of each pole face of the said electromagnetic assembly reverses therewith.

4. The multi-phase rotating motor according to claim 2, characterized in that: the said electromagnetic assembly have coils and a magnetically conductive connection part, when the coils of the said electromagnetic assembly are subjected to current excitation, a single magnetic field polarity is generated on each pole face of the said electromagnetic assembly and opposite magnetic field polarities are generated on the adjacent pole faces of the said electromagnetic assembly, and when the currents passing through the coils reverse, the magnetic field polarity of each pole face of the said electromagnetic assembly reverses therewith.

5. The multi-phase rotating motor according to claim 4, characterized in that: each magnetic pole of the magnetic assembly of each said magnetic track of the said field magnet member and adjacent magnetic poles of the adjacent magnetic assemblies arrayed in the circumferential direction in which the rotating shaft surrounds are continuously and alternatively configured in magnetic pole polarity in the circumferential direction in which the rotating shaft surrounds.

6. The multi-phase rotating motor according to claim 5, characterized in that: the electromagnetic assemblies are respectively fixed by a support structure made of non-magnetically conductive material so that no ferromagnetic contact is present between the electromagnetic assemblies.

7. The multi-phase rotating motor according to claim 6, characterized in that: the said magnetic tracks of the said field magnet member are in non-ferromagnetic contact with each other along adjacent magnetic assemblies in the circumferential direction in which the rotating shaft surrounds.

8. The multi-phase rotating motor according to claim 6, characterized in that: permanent magnets of each magnet assembly are integrated with each other by a connection part made of magnetically conductive material so that the permanent magnets forming the magnetic poles of the magnet assemblies only show a single magnetic field polarity on the surface facing the air gap and the magnetic field polarity is opposite to the magnetic field polarity on the back surface of the permanent magnets combined to the connection part of the magnetic assemblies.

9. The multi-phase rotating motor according to claim 1, characterized in that: each magnetic pole face of two magnetic poles of each magnetic assembly additionally includes the corresponding pole face in a second direction vertical to the circumferential direction in which the rotating shaft surrounds, and the second direction is vertical to the first direction, and each pole face of the paired poles of the electromagnetic assemblies of the each-phase unit additionally includes the pole face in the second direction vertical to the circumferential direction in which the rotating shaft surrounds so that each pole face of the paired poles of the electromagnetic assemblies of the each-phase unit is separated by the air gap from the corresponding magnetic pole face of two magnetic poles of the corresponding magnetic assemblies in the second direction vertical to the circumferential direction in which the rotating shaft surrounds.
